(19) United States
(12) Patent Application Publication
(10) Pub. No.: US 2007/0214014 A1
(43) Pub. Date: Sep. 13, 2007

(54) Pharmacy quality checking and alert system and method

(76) Inventors: Michael W. Suwalski, South Elgin, IL (US); Sam Libo, Deerfield, IL (US); Thomas Ochocinski, Northbrook, IL (US)

Correspondence Address: NEAL, GERBER, & EISENBERG, SUITE 2200, 2 NORTH LASALLE STREET, CHICAGO, IL, 60602, US

(21) Appl. No.: 11/367,636

(22) Filed: Mar. 3, 2006

(51) Int. Cl. G06F 19/00

(52) U.S. Cl. 705/3; 700/109

(57) ABSTRACT

The disclosure presents a system and method for preventing pharmacy errors for a prescription. The system and method receives prescription data comprising medication data and direction data for the delivery of medication identified within the medication data for the prescription, transmits the prescription data to a pharmacy computer memory associated with a pharmacy prescription entry and fill computer. The system and method further compares, at the pharmacy entry and fill computer, the direction data for the prescription to error prevention keyword data for the medication data, wherein the error prevention keyword data is stored in an error prevention keyword database associated with the pharmacy entry and fill computer and the pharmacy computer memory. A possible directions error message is transmitted to a display of a communication device for viewing by pharmacy personnel in response to the comparison. The disclosure also presents a system and method for preventing internal pharmacy errors for a specialty prescription. The system and method receives prescription data comprising medication data for a prescription, and transmits the prescription data to a pharmacy computer memory associated with a pharmacy prescription entry and fill computer. The pharmacy entry and fill computer compares the medication data for the prescription to specialty prescription data stored in a specialty prescription database. The system and method further transmits first specialty prescription dispensing task information to a display of a communication device for viewing by pharmacy personnel, and for preventing the pharmacy personnel from dispensing the prescription without performing the first specialty prescription dispensing task, in response to the comparing step.

### CROSS-REFERENCE TO RELATED APPLICATIONS

None.

### TECHNICAL FIELD

The present invention is related to a system and method for preventing errors which can occur in a pharmacy operation. More particularly, the present invention relates to a system and method for automatically alerting a pharmacy attendant of potential errors in the prescription entry, fill, and dispensing processes, as well as for providing dispensing restrictions for handling specialty drugs.

### BACKGROUND OF THE INVENTION

Patients commonly obtain their prescribed medications through pharmacies. One system used for delivering medications to patients is disclosed in U.S. Patent Publication No. 2004/0088187 A1, published May 6, 2004, to Chudy et al. The Chudy reference is directed to optimizing pharmacy workflow associated with fulfillment of prescription orders for medications and health related products in a pharmacy environment. The system coordinates and controls pharmacy workflow to sequence prescriptions for fulfillment in an attempt to make the process efficient and to minimize a cost function associated with fulfillment of the prescription order. The Chudy reference also specifies validating prescription orders. Computer program instructions are used for validating each prescription order at a work station, including steps of selecting a prescription from the prescription sequence presented on a display, reading machine-readable indicia on a label of a container corresponding to each selected prescription, and releasing the prescription only after agreement is reached between the readable indicia and prescription. Prior to releasing the prescription, the customer's medical records may be automatically searched to determine whether there are potential adverse drug interactions between the patient and the prescription(s). However, the Chudy reference fails to address preventing possible errors within the directions or the dispensing of specialty drugs within a pharmacy operation.

One additional prior system is disclosed in U.S. Publication No. 2003/0144884 A1, published Jul. 31, 2003, to Mayaud. One embodiment of the Mayaud reference is directed to a computer-implemented prescription management system to assist physicians in prescribing and reviewing drugs. The system is not directed to catching possible errors or making sure certain procedures are followed for dispensing prescriptions by a pharmacy. Thus, Mayaud fails to address preventing possible errors within the directions or the dispensing of specialty drugs in a pharmacy operation.

One additional prior system is disclosed in U.S. Publication No. 2003/0074225 Al, published Apr. 17, 2003, to Borsand et al. The Borsand et al. reference is directed to a system for facilitating direct communications between a payor, a pharmacy benefits manager, a pharmacy, and a health care provider, such as a physician. The system can check for unfavorable pharmaceutical interactions and allergic reactions, prevent misuse of a prescription, monitor the filling and re-filling of a prescription, as well as cancel a prescription after it has been issued by a provider. However, the Borsand et al. reference fails to address preventing possible errors within the directions or the dispensing of specialty drugs in a pharmacy operation.

The present invention is provided to solve or address these and other problems.

### SUMMARY OF INVENTION

The present pharmacy error prevention system and method includes detailed data collection mechanisms integrated into daily work flows within a pharmacy. The system and method further utilizes the collected data to perform particular comparisons or “checks” for quality assurance and safety. In one embodiment, a method is provided for preventing pharmacy errors for a prescription, such as internal errors which can occur in entering the directions into a pharmacy computer management system for a prescription. The method includes receiving prescription data comprising medication data and direction data for the delivery of medication identified within the medication data for the prescription. The method also includes transmitting the prescription data to a pharmacy computer memory associated with a pharmacy prescription entry and fill computer. The method further includes comparing, at the pharmacy entry and fill computer, the direction data for the prescription to error prevention keyword data for the medication data, stored in an error prevention keyword database associated with the pharmacy entry and fill computer and the pharmacy computer memory. The method also includes transmitting a possible directions error message to a display of a communication device for viewing by pharmacy personnel in response to the comparing step.

In one embodiment, the prescription data further comprises patient data and prescriber data. In another embodiment, the step of comparing only occurs when the medication data comprises a predetermined medication. In another embodiment, the error prevention keyword data comprises an error prevention keyword, wherein if the direction data does not comprise the error prevention keyword, then the possible directions error message will be transmitted to the display of the communication device. In a further embodiment, the error prevention keyword data comprises an error prevention keyword, wherein if the direction data comprises the error prevention keyword, then the possible directions error message will be transmitted to the display of the communication device.

In another embodiment, the error prevention keyword data comprises a plurality of error prevention keywords, and if the direction data does not comprise all of the plurality of error prevention keywords, then the possible directions error message will be transmitted to the display of the communication device. In a further embodiment, the error prevention keyword data comprises a plurality of error prevention keywords, wherein if the direction data comprises all of the plurality of error prevention keywords, then the possible directions error message will be transmitted to the display of the communication device. In a further embodiment, the error prevention keyword data comprises a plurality of error prevention keywords, and if the direction data does not comprise at least one of the plurality of error prevention keywords, then the possible directions error message will be transmitted to the display of the communication device. In a further embodiment, the error prevention keyword data comprises a plurality of error prevention keywords, and if the direction data comprises at least one of the plurality of error prevention keywords, then the possible directions error message will be transmitted to the display of the communication device.

In a further embodiment, the method further includes transmitting the possible directions error message to a display of a communication device while the display is displaying one of a prescription entry interface screen or a prescription data review interface screen.

In an additional embodiment, the method includes receiving the error prevention keyword data for a particular medication, transmitting the error prevention keyword data for the particular medication, and storing error prevention keyword data in the error prevention keyword database associated with the pharmacy entry and fill computer.

In one embodiment a system is provided for preventing pharmacy errors for a prescription, such as internal errors which can occur in entering the directions into a pharmacy computer management system for a prescription. The system includes an input device for receiving prescription data comprising medication data and direction data for the delivery of medication identified within the medication data for the prescription. The system also includes a pharmacy computer memory in communication with the input device for receiving the prescription data from the input device, and a pharmacy prescription entry and fill computer in communication with the pharmacy computer memory, configured to compare the direction data for the prescription to error prevention keyword data for the medication data. The system also includes an error prevention keyword database in communication with the pharmacy entry and fill computer and the pharmacy computer memory, wherein the error prevention keyword database is configured to store the error prevention keyword data. The system further includes a communication device having a display configured to receive and display a possible directions error message for viewing by pharmacy personnel in response to the pharmacy prescription entry and fill computer comparing the direction data to the error prevention keyword data. The error prevention keyword database can be configured to receive and store error prevention keyword data for each of a plurality of particular medications.

In another embodiment, the present invention is directed to a method of preventing internal pharmacy errors for a specialty prescription. The method includes receiving prescription data comprising medication data for a prescription. The method further includes transmitting the prescription data to a pharmacy computer memory associated with a pharmacy prescription entry and fill computer. The method also includes comparing, at the pharmacy entry and fill computer, the medication data for the prescription to specialty prescription data, stored in a specialty prescription database associated with the pharmacy entry and fill computer and the pharmacy computer memory. The method additionally includes transmitting first specialty prescription dispensing task information to a display of a communication device for viewing by pharmacy personnel, and for preventing the pharmacy personnel from dispensing the prescription without performing the first specialty prescription dispensing task, in response to the comparing step.

The step of transmitting the first specialty prescription dispensing task information can include transmitting first compliance verification data for viewing by the pharmacy personnel, requiring the pharmacy personnel to verify that the pharmacy personnel has complied with the first specialty prescription dispensing task, wherein the pharmacy personnel cannot complete filling the prescription until the first specialty prescription dispensing task has been verified. The first compliance verification data can include data for causing a check off box to be displayed on the display of the communication device, requiring the pharmacy personnel to check off that the pharmacy personnel has complied with the first specialty prescription dispensing task. In one embodiment, the first specialty prescription dispensing task information is transmitted to the display of the communication device only if the medication data comprises a medication selected from the group consisting of clozapine, isotretinoin, Lotronex, Tikosyn, Accutane, and methotrexine.

The method can also include receiving first specialty prescription dispensing task information for a particular specialty medication, and transmitting the first specialty prescription dispensing task information for the particular specialty medication. The method can further include storing the first specialty prescription dispensing task information in the specialty prescription database associated with the pharmacy entry and fill computer.

Other features and advantages of the invention will be apparent from the following specification taken in conjunction with the following drawings.

### BRIEF DESCRIPTION OF THE DRAWINGS

FIG. 1 is a schematic diagram showing a top plan view of a conventional pharmacy operation.

FIG. 2 is a schematic diagram illustrating one or more embodiments of a pharmacy management system for preventing errors which occur in a single or multiple pharmacy store operation;

FIG. 3 is a prescription entry interface screen of one embodiment of the system of FIG. 2 providing for entry of pharmacy prescription data information;

FIG. 4 is a prescription data review interface screen of another embodiment of the system of FIG. 2, providing a quality alert message, such as a directions error message, in response to a directions quality check;

FIG. 5 is a prescription entry interface screen of another embodiment of the system of FIG. 2, providing a quality alert message, such as a directions error message, in response to a directions quality check;

FIG. 6 is a prescription data review interface screen of another embodiment of the system of FIG. 2, providing a quality alert message, such as a directions error message, in response to a directions quality check;

FIG. 7 is a prescription entry interface screen of another embodiment of the system of FIG. 2, providing a quality alert message, such as a directions error message, in response to a directions quality check;

FIG. 8 is a pharmacy drug information review and entry interface screen of one embodiment of the system of FIG. 2;

FIG. 9 is a quality alert keyword and alert/possible error message review and entry interface screen of one embodiment of the system of FIG. 2;

FIG. 10 is a drug indicators interface screen of one embodiment of the system of FIG. 2, for selecting or entering a specialty drug;

FIG. 11 is a drug indicators interface screen of FIG. 10, for selecting or entering a specialty drug, and for determining dispensing task information for the selected specialty drug;

FIG. 12 is a drug dispensing restrictions interface screen of one embodiment of the system of FIG. 2, for providing specialty prescription dispensing task information for a particular specialty drug;

FIG. 13 is a drug dispensing restrictions interface screen of one embodiment of the system of FIG. 2, for providing specialty prescription dispensing task information for another particular specialty drug;

FIG. 14 is a drug dispensing restrictions interface screen of one embodiment of the system of FIG. 2, for providing specialty prescription dispensing task information for a further particular specialty drug;

FIG. 15 is a drug dispensing restrictions interface screen of one embodiment of the system of FIG. 2, for providing specialty prescription dispensing task information for a another particular specialty drug;

FIG. 16 is a drug dispensing restrictions interface screen of FIG. 13, providing an additional verification task;

FIG. 17 is a drug dispensing restrictions interface screen of FIG. 13, providing a further verification task; and,

FIG. 18 is a drug code maintenance interface screen of one embodiment of FIG. 2, for receiving and storing specialty prescription dispensing task information, such as linking information, for a particular specialty drug or medication.

### DETAILED DESCRIPTION

While this invention is susceptible to embodiment in many different forms, there are shown in the drawings and herein described in detail preferred embodiments with the understanding that the present disclosure is considered to provide an example of the principles of the invention, and is not intended to limit the broad aspect of the invention to the embodiments illustrated.

The “dispensing” of medication for a prescription involves entering, filling, verifying and selling the prescription including the medication. Errors can occur within the entering and filling process. The present invention is directed to preventing particular pharmacy error events, such as internal pharmacy error events. A pharmacy error event is any occurrence that prevents the pharmacy from filling any prescription correctly the first time, every time, and can include at least dispensing a prescription with incorrect directions for a particular drug, and/or dispensing a specialty drug without paying attention to particular requirements for such specialty drug. Other pharmacy error events can include such things as a prescription being somewhat unreadable requiring a call to the prescribing MD, or picking the wrong bottle from a shelf and then getting an automated or non-automated warning that the medication is wrong. Many other types or errors can occur.

The present invention is directed to reducing certain types of errors in a pharmacy. The invention can be located and used in any environment wherein medications are dispensed in order to fill prescription orders, where human intervention in the order-filling process takes place. Thus, the term “pharmacy” is intended to include diverse environments including retail pharmacies, pharmacies in alternate site facilities, hospital pharmacies and the like.

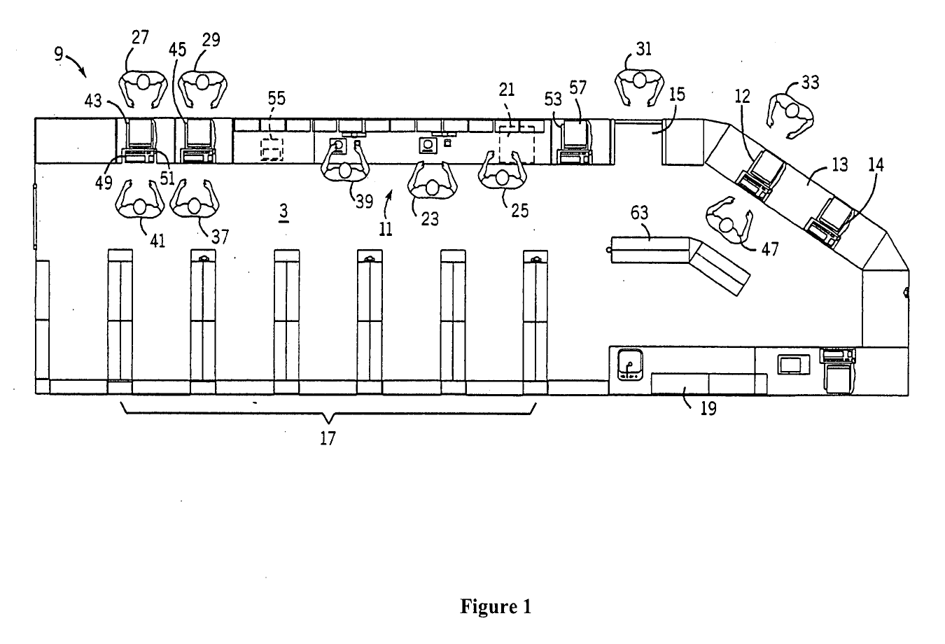

The improved pharmacy management system 1 of the present invention will be described with respect to an exemplary and conventional pharmacy layout illustrated in FIG. 1. Specifically, referring now to FIG. 1, a conventional pharmacy 3 shown therein includes an order entry workstation 9, a filling/checking workstation 11, a payment workstation 13 and a consultation workstation 15. Conventional pharmacy 3 is provided with any number of non-automated storage locations at which medications and products are stored for access by pharmacy personnel. For example, the pharmacy 3 shown in FIG. 1 is provided with an array of six static storage shelf units 17. Each storage shelf unit within the array 17 is typically about 6 to 8 feet in height and includes a plurality of spaced-apart horizontally-oriented shelves. Medications and products are stored on each shelf within the array 17 pending manual retrieval for fulfillment of a prescription order.

Pharmacy 3 may include other storage locations such as a restricted-access cabinet 19 for storage of narcotics and other controlled medications. Pharmacy 3 may also include a refrigerator 21 for storage of perishable medications and articles.

Pharmacy 3 is staffed by personnel having varying levels of responsibility. The pharmacy staff includes at least one registered pharmacist 23, 25. Each pharmacist (e.g., pharmacist 23) is responsible for fulfillment of prescription orders and for verification of each prescription order before the order is provided to a customer 27-35. One or more filling technicians 37, 39 may be employed to assist pharmacists 23, 25 in fulfilling each prescription order. The pharmacists 23, 25 or filling technicians 37, 39 may also provide health-care-related information to a customer 31 at consultation station 15.

A data entry clerk or technician 41 is provided to supply prescription order information to a host computer and pharmacy information system (not shown) via computer terminal 43 or 45 at data entry station 9. A sales clerk 47 processes sales transactions at the payment workstation 13 using computer terminal 14 or 16.

Workflow at conventional pharmacy 3 may be summarized in the following manner. Data entry clerk or other pharmacy staff or technician 41 may input the prescription order information to the system at data entry workstation 9 using keyboard 49 or computer mouse 51 of computer 43. Following adjudication by the pharmacy information system, each adjudicated order is held in a database on pharmacy computer 53 at filling/checking workstation 11 for fulfillment, typically on a first in first out (“FIFO”) basis. Labels for attachment to each container associated with the prescription order may be printed on printer 55.

Pharmacist 23, 25 or filling technician 37, 39 selects the prescription order next in line to be filled. The prescription order, and prescriptions comprising the order, may be displayed on a communications device, such as a display 57 associated with computer 53. The prescriptions making up the prescription orders are not arranged in any particular sequence.

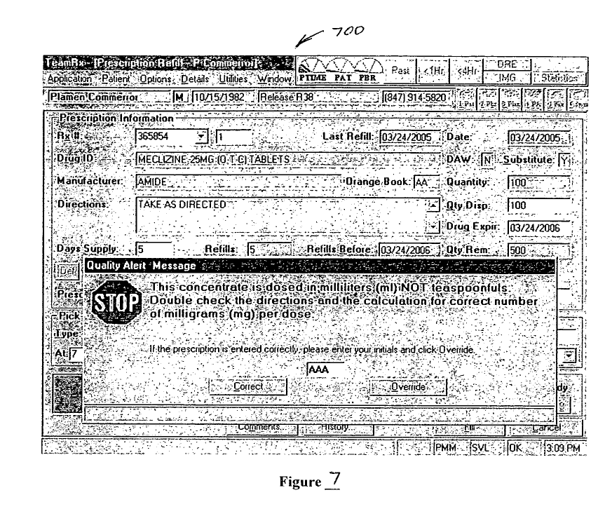

The pharmacist 23, 25 or filling technician 37, 39 then fills each prescription in the prescription order. Each prescription in the prescription order is filled by walking to one of the storage locations 17-21 and retrieving the appropriate medication which may be in bulk-form or in prepackaged form. The medication is then taken from the storage location 17-21 to the filling/checking work station 11 where the appropriate number of medications are metered into a container, such as vial 59 with reclosable cap 61 (FIG. 7A), in accordance with the prescription order. The corresponding label is placed on each container (e.g., vial, box, etc.).

This process is repeated until each prescription in the prescription order is fulfilled. The prescription order is then verified by pharmacist 23, 25 at filling/checking work station 11 to ensure that the correct medication is in each container (e.g., vial, box, etc.). The fulfilled order is then placed in a bag or other package and is held at a “will call” area 63 near payment work station 13. Sales clerk 47 processes the transaction and delivers the packaged prescription order to customer 33 at the payment work station 13.

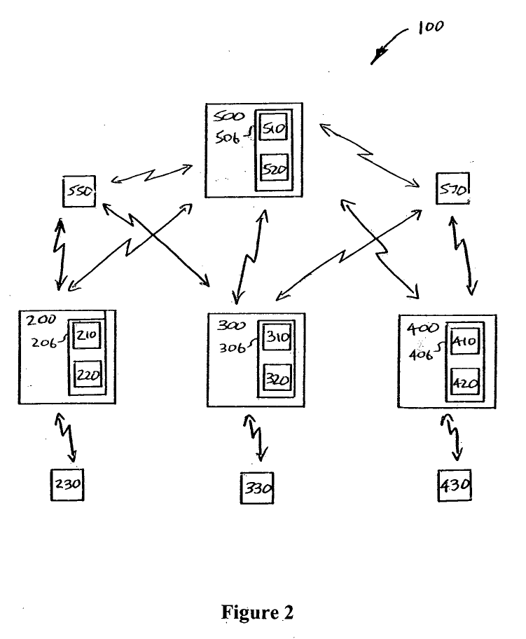

Referring to FIG. 2, there is shown a pharmacy management system 100 for efficiently entering, filling and dispensing prescriptions in an integrated manner in relation to the distribution of medication to patients through a single or multi-store pharmacy operation. As shown in FIG. 2, a single or multi-server based arrangement can be used to implement the system 100.

The pharmacy management system 100 can be implemented in software running on various hardware platforms. A first pharmacy management computer 200 can be provided for a first pharmacy store, a second pharmacy management computer 300 can be provided for a second pharmacy store, and a third pharmacy management computer 400 can be provided for a third pharmacy (can be many others). A district, corporate or central pharmacy management computer 500 can be provided for centralizing various data and/or for providing functionality which would otherwise be provided by the first, second and/or third pharmacy management computers 200, 300, 400, as briefly mentioned above, and as will be described in greater detail below. The first pharmacy management computer 200 has a first processor and a first memory 206 having a first pharmacy prescription, patient, and/or medication database 210 and having first pharmacy management software modules 220 for performing various pharmacy entry, filling, dispensing and error event prevention/reduction functions as briefly described above, and as will be described in greater detail below. The first pharmacy management computer 200 is in communication with a first input device 230 (can be many others), such as a hand-held or desk-top computer terminal, which is located at the first pharmacy store, for receiving patient data, prescription data, medication data, and other data for filling and dispensing medication to patients within the first pharmacy. The first input device 230 transmits the patient data, prescription data, medication data, and/or other data to the first pharmacy management computer 200 and to the first pharmacy prescription, patient, and/or medication database 210 for storage therein. Interface screens, described below, are displayed through the first input device for at least receiving the prescription data, and for other functions, which are provided at least in part by the pharmacy management software modules 220 from the first pharmacy management computer 200. The first pharmacy management computer 200 may be located at the first pharmacy or elsewhere.

The second pharmacy management computer 300 has a second processor and a second memory 306 having a second pharmacy prescription, patient, and/or medication database 310 and having second pharmacy management software modules 320 for performing various pharmacy entry, filling, dispensing and error event prevention/reduction functions, as briefly described above, and as will be described in greater detail below. The second pharmacy management computer 300 is in communication with a second input device 330 (can be many others), such as a hand-held or desk-top computer terminal, which is located at the second pharmacy store, for receiving patient data, prescription data, medication data, and other data for filling and dispensing medication to patients within the second pharmacy. The second input device 330 transmits the patient data, prescription data, medication data, and/or other data to the second pharmacy management computer 300 and to the second pharmacy prescription, patient, and/or medication database 310 for storage therein. Interface screens, described below, are displayed through the second input device for at least receiving the prescription data, and for other functions, which are provided at least in part by the pharmacy management software modules 320 from the second pharmacy management computer 300. The second pharmacy management computer 300 may be located at the second pharmacy or elsewhere.

Likewise, the third pharmacy management computer 400 has a third processor and a third memory 406 having a third pharmacy prescription, patient, and/or medication database 410 and having third pharmacy management software modules 420 for performing various pharmacy entry, filling, dispensing and error event prevention/reduction functions, as briefly described above, and as will be described in greater detail below. The third pharmacy management computer 400 is in communication with a third input device 430 (can be many others), such as a hand-held or desk-top computer terminal, which is located at the third pharmacy store, for receiving patient data, prescription data, medication data, and other data for filling and dispensing medication to patients within the third pharmacy. The third input device 430 transmits the patient data, prescription data, medication data, and/or other data to the third pharmacy management computer 400 and to the third pharmacy prescription, patient, and/or medication database 410 for storage therein. Interface screens, described below, are displayed through the third input device for at least receiving the prescription data, and for other functions, which are provided at least in part by the pharmacy management software modules 420 from the third pharmacy management computer 400. The third pharmacy management computer 400 may be located at the third pharmacy or elsewhere.

As mentioned, the district, corporate or central pharmacy management computer 500 can be provided for centralizing management data and/or for providing functionality which would otherwise be provided by the first, second and/or third pharmacy management computers 200, 300, 400 (can be many others). Specifically, the district, corporate or central pharmacy management computer 500 has a central processor and a central memory 506 having a central pharmacy prescription, patient, and/or medication database 510 and having central pharmacy management software modules 520 for performing various pharmacy entry, filling, dispensing and error event prevention/reduction functions as briefly described above and as will be described in greater detail below. In one embodiment, the central pharmacy management computer 500 is in communication with the first, second, and/or third pharmacy management computers 200, 300, 400 for centralizing all or part of the prescription, patient, medication, and other data received, processed, and stored at such computers 200, 300, 400.

Pharmacy data can be reviewed, tracked and analyzed on a cumulative and other global bases from supervisory terminal devices 550, 570, which can for example be a hand-held or desk-top computer, as will be described in further detail below. Alternatively, the central pharmacy management computer 500 can be directly in communication with first, second, and third input devices 230, 330, 430 (can be many others) for receiving and processing pharmacy data for prescriptions, patients, medications, and/or other data received from where the input devices 230, 330, 430 are located, or relating to prescriptions which have been filled or provided to patients through various pharmacies within a multi-store pharmacy enterprise. The input devices 230, 330, 430 transmit the pharmacy data to the central pharmacy management computer 500 either directly or through other computers or systems, and to the central pharmacy prescription, patient and/or medication database 510 for storage therein. Interface screens, described below, are displayed through the input devices 230, 330, 430 and through supervisory interface devices 550, 570 for at least receiving the pharmacy data, and for other functions, which are provided at least in part by the pharmacy management software modules 520 from the central management computer 500. In one embodiment, the central pharmacy management computer 500 is located remotely from the pharmacies, and at the corporate or enterprise main offices.

As generally indicated, the system 100 can be implemented in the context of FIG. 1, FIG. 2, or other configurations, in software, as an executable program(s), such as through the software modules 220, 320, 420, 520 including the interface modules therein, executed by one or more special or general purpose digital computer(s), such as a personal computer (PC; IBM-compatible, Apple-compatible, or otherwise), personal digital assistant, workstation, minicomputer, server, or mainframe computer.

As mentioned, in terms of hardware architecture shown in FIG. 2, the computer systems and devices mentioned in FIG. 1 and one or more of the computers 200, 300, 400, 500 and input devices 230, 330, 430, 550, 570 mentioned in FIG. 2 can include a processor, memory, and one or more input and/or output (I/O) devices 306 (or peripherals) that are communicatively coupled via a communication interface. The communication interface can be, for example, but not limited to, one or more buses or other wired or wireless connections, as is known in the art. The communication interface may have additional elements, which are omitted for simplicity, such as controllers, buffers (caches), drivers, repeaters, and receivers, to enable communications. Further, the interface may include address, control, and/or data connections to enable appropriate communications among the other computer components.

The processors are hardware devices for executing software, particularly software stored in memory, such as memory 206, 306, 406, 506. The processor can be any custom-made or commercially available processor, a central processing unit (CPU), an auxiliary processor among several processors associated with the computers 200, 300, 400, 500 and input/interface devices 550, 570, a semiconductor-based microprocessor (in the form of a microchip or chip set), a microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. The processors may also represent a distributed processing architecture such as, but not limited to, SQL, Smalltalk, APL, KLisp, Snobol, Developer 200, MUMPS/Magic.

The memory 206, 306, 406, 506, and other memories, can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. The memory can have a distributed architecture where various components are situated remote from one another, but are still accessed by the processors.

The pharmacy management software 220, 320, 420, 520 in respective memory 206, 306, 406, 506 may include one or more separate programs or modules. The separate programs comprise ordered listings of executable instructions for implementing logical functions. In the example of FIG. 1, the software in memory, including memory of I/O devices 230, 330, 430, 550, 570, also includes a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run-time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system essentially controls the execution of other computer programs, such as the pharmacy management software 220, 320, 420, 520 of system 100, and provides scheduling, input-output control, file and data management, memory management, and communication control and related services.

The pharmacy management software 220, 320, 420, 520 of system 100 may be a source program, executable program (object code), script, or any other entity comprising a set of instructions to be performed. When using a source program, the program needs to be translated via a compiler, assembler, interpreter, or the like, which may or may not be included within the memory, so as to operate properly in connection with the O/S. Furthermore, the pharmacy management software 220, 320, 420, 520 of system 100 can be written as (a) an object-oriented programming language, which has classes of data and methods, or (b) a procedural programming language, which has routines, subroutines, and/or functions, for example but not limited to C, C++, Pascal, Basic, Fortran, Cobol, Perl, Java, and Ada. In one embodiment, the pharmacy management software 220, 320, 420, 520 of system 100 is written in Cow, Java and/or html for use with client type I/O devices.

The I/O devices may include input devices, for example but not limited to a keyboard, mouse, scanner, microphone, touch screens, interfaces for various communications devices, barcode readers, stylus, laser readers, radio-frequency device readers, etc. Furthermore, the I/O devices may also include output devices, for example but not limited to a printer, barcode printers, displays, etc. Finally, the I/O devices may further include devices that communicate both inputs and outputs, for instance but not limited to a modulator/demodulator (modem; for accessing another device, system, or network), a radio frequency (RF) or other transceiver, a telephonic interface, a bridge, and a router.

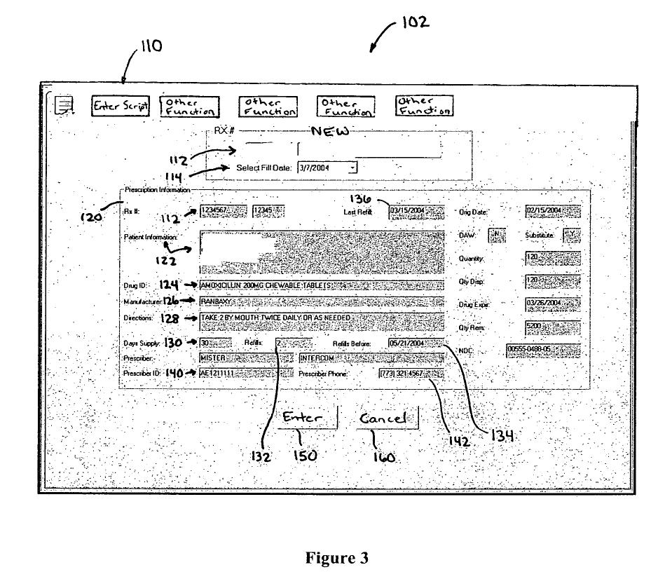

If the computer 200, 300, 400, 500 and/or I/O devices 230, 330, 430, 550, 570 is a PC, workstation, PDA, or the like, the software in the memory may further include a basic input output system (BIOS) (not shown in FIG. 3). The BIOS is a set of essential software routines that initialize and test hardware at startup, start the O/S, and support the transfer of data among the hardware devices. The BIOS is stored in ROM so that the BIOS can be executed when the computer is activated.

When computer 200, 300, 400, 500 is in operation, the respective processors are configured to execute software stored within memory 206, 306, 406, 506, to communicate data to and from memory 206, 306, 406, 506, and to generally control operations of the computer(s) 200, 300, 400, 500, pursuant to the software. The pharmacy management software 220, 320, 420, 520 of system 100, and the O/S, in whole or in part, but typically the latter, are read by processor(s), perhaps buffered within the processor, and then executed.

It should be noted that pharmacy management software 220, 320, 420, 520 can be stored on any computer-readable medium for use by or in connection with any computer-related system or method. In the context of this document, a computer readable medium is an electronic, magnetic, optical, or other physical device or means that can contain or store a computer program for use by or in connection with a computer related system or method. The pharmacy management software 220, 320, 420, 520 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable media would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Specifically, the pharmacy management software 220, 320, 420, 520 of system 100 has a data entry module, a data review module, and a prescription dispensing and/or filling module, for at least entry review and/or dispensing/filling a prescription having prescription information. One or more of these software modules and/or other software modules include code for preventing errors from being entered into the database for prescription directions (SIG) and/or for preventing errors from occurring in the dispensing of a specialty prescription. As a side note, a detailed organizational hierarchy can be stored and utilized for these and other functions within one or more of the pharmacy databases 210, 310, 410, 510, for use within the pharmacy management system 100. As mentioned above, there are various different players or personnel in a pharmacy and in a pharmacy enterprise or organization. At each pharmacy store, there are one or more technicians (Tx or Tech) who receive prescriptions, enter prescriptions into the pharmacy management system 100, pick prescriptions, and fill prescriptions. Each pharmacy also has one or more pharmacists (Rx) who also are involved with prescription filling, at least in checking the accuracy of the filling of the prescription before being provided to the patient. A store manager (SM) and a pharmacy supervisor (RxS) are additional personnel within each pharmacy store. Pharmacy supervisors (RxS) can also be “located” at the district level. A district manager (DM) or pharmacy supervisor (RxS) can be responsible for two or more stores which can be classified as a district. Regional managers (RM) can also be involved in the process described herein and are responsible for two or more districts which make up such region. Quality assurance (QA) and/or personnel at the corporate level are responsible for all of the regions, districts, and stores and are also involved in the process described herein.

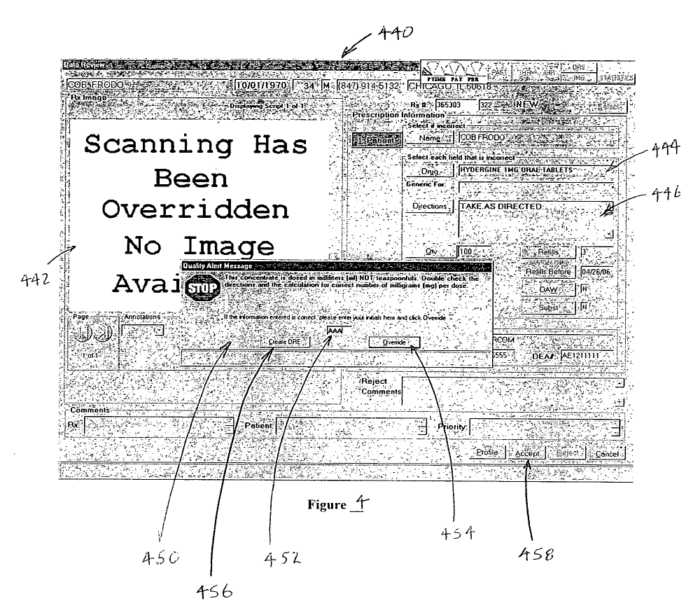

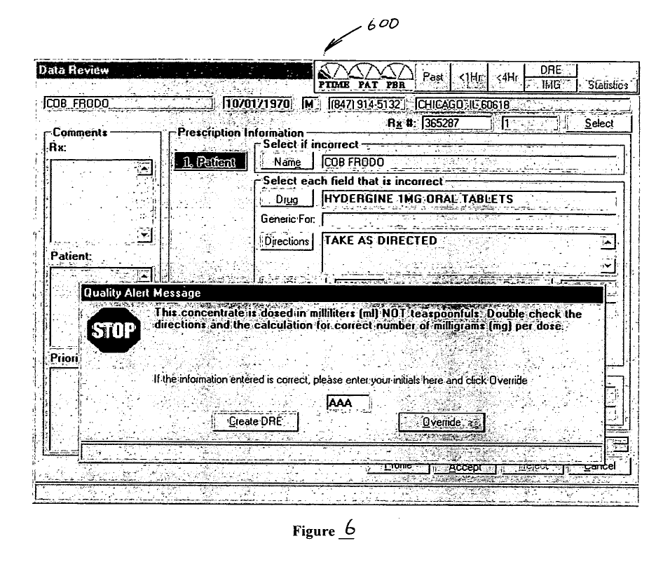

The pharmacy management computers, software modules, and databases are utilized throughout the process of receiving, filling and dispensing prescriptions, including some automated checking of whether a prescription order has been correctly filled, as indicated above. The system 100 includes automated checking, specialty drug handling functionality and interface screens, alerts, and messages therefore. In other words, the pharmacy prescription, patient, and/or medication data, and in particular the prescription data, can be checked for quality control, such as through automated error prevention and specialty dispensing treatment, provided through the software modules mentioned above. In one embodiment, one or more of these features and functions can be utilized through an “In Window” or prescription entry interface screen, such as the interface screens shown in at least FIGS. 3, 5, 7, and 12-17. In another embodiment, one or more of these features and functions can be utilized through a “Data Review” interface screen, such as the interface screens shown in at least FIGS. 4 and 6.

Specifically, referring to FIG. 3, a prescription or “script” entry interface screen 102 is shown. In this embodiment, the interface screen 102 is entitled “Enter Script,” which can be selected by “clicking” on an “Enter Script” tab 110. The Enter Script interface screen 102 allows a pharmacist or technician to enter basic information regarding a prescription. A prescription number “RX#” 112 is generated by the system when entry of a new prescription begins (or can be generated after a new prescription is fully entered) by the technician, through at least input devices 230, 330, 430. The fill date 114 (which can be selected from a calendar or which can be automatically entered or filled in by the system) is also entered by the technician. If a patient has already been entered into the system 100 from previous prescriptions being filled through one of the first, second and/or third pharmacy computers 200, 300, 400, respectively, the technician can “look up” the patient by entering the name of or other piece of information about the patient into the patient information field 122. Once verified by the patient, or some other mechanism for verification, the remaining information for the patient can be automatically filled in by the data entry module of the pharmacy management software by requesting such data from within the prescription, patient, and/or medication database 210, 310, 410, 510. The patient information entered into the patient information field 122, (patient name, address, phone number, e-mail address, etc.) can be entered manually as well, instead of being automatically populated. The technician also then enters the drug or medication name into a drug identification field 124, a manufacturer name for the identified drug through the manufacturer name field 126, the directions for taking the prescription (SIG) through the directions field 128, as well as days supply information through a days supply field 130, number of refills through a refills field 132, number of refills before a certain date into a refills before field 134 (no refills after date), last refill into a last refill date field 136 (for prescriptions that are not “new”), prescriber name into a prescriber name field 138, a prescriber ID into a prescriber ID field 140, a prescriber phone number into a prescriber phone number field 142, and other information into other fields within the prescription as shown in FIG. 3. An enter button 150 can be provided to “enter” the prescription into the database upon completion or all or at least a portion of the entry of the prescription into the prescription entry interface screen 102. A cancel button 160 can also be provided to cancel out of this interface screen without saving any data to the database.

After the entry of the drug or medication name into the drug identification field 124, either at the time it is entered or upon completion of the entire prescription, the system 100 will then check directions data or begin looking for directions data entered into or to be entered into the directions data field 128 and/or any other field which may include directions data, to determine if the directions data is consistent with the drug name entered into the drug identification field 124. The input device 230, 330, 430, and/or 530 can receive the prescription data, including the drug or other medication data through the drug identification field 124 and directions data through the directions data field 128 of other field, for the delivery of the medication identified within the medication data for the prescription being entered. This prescription data is transmitted to a pharmacy computer memory associated with a pharmacy prescription entry and fill computer, such as one or more of the pharmacy management computers 200, 300, 400, and/or 500. The pharmacy entry and fill, or management computers 200, 300, 400, and/or 500 compare the direction data for the prescription to error prevention keyword data for the entered medication data, which is stored in an error prevention keyword database 210, 310, 410, and/or 510 associated with the pharmacy entry and fill computer 200, 300, 400, and/or 500 and the pharmacy computer memory 206, 306, 406, and/or 506, as will be described in greater detail below. If the comparison reveals an inconsistency between the entered medication data and the entered directions data, the pharmacy entry and fill computer 200, 300, 400 and/or 500 will transmit a message to a display of a communication device, such as the input device 230, 330. 430, 550, and/or 570 for viewing by pharmacy personnel. The message will indicate there may be a possible error with the directions being entered or already entered for the prescription in question, as generally shown in FIGS. 4-7. In one embodiment of the prescription entry interface screen 102, this error checking will only occur on the first entry of a prescription. In another embodiment, this checking can be performed for refills and during data review of a previously entered prescription.

Referring additionally to FIGS. 4-7, FIG. 4 shows a further embodiment of a data review interface screen 440. This interface screen 440 can be used to review entered prescriptions after one has been entered into the system. In particular, this interface screen 440 is used for data review of a prescription entered and/or captured using an image capture of the actual written prescription, which would be shown in the prescription image area 442 (a prescription is not actually shown in image area within FIG. 4). The data review interface screen 440 also shows the patient name and other information similar to the prescription entry interface screen 102 of FIG. 3. However, the data review interface screen 440 of FIG. 4 allows the technician, pharmacist or other personnel to select fields if the information in such fields are incorrect and/or for some reason need to be changed. If the identification of the medication in medication field 444 is changed, then new directions may need to be entered into the directions field 446. In addition, a technician, pharmacist or other personnel reviewing the data may wish to change the directions information in the directions field 446 if there is something that is not correct in the directions field 446. In either case, similar to when directions are entered during initial entry of the prescription through the prescription entry interface screen 102, the system will determine if the directions data is consistent with the drug name entered into the drug or medication identification field 444, as described above.

A quality alert message 450 is also shown in FIG. 4. In particular, when the comparison reveals an inconsistency between the entered medication data and the entered directions data, the pharmacy entry and fill computer 200, 300, 400 and/or 500 will transmit a message to a display of a communication device, such as the input device 230, 330, 430, 550, and/or 570 for viewing by pharmacy personnel. The message will indicate there may be a possible error with the directions being entered or already entered for the prescription in question. In the quality alert message 450 of FIG. 4, the system has detected that the directions field 446 and/or other field includes an indication that the previously entered prescription may include an indication to take the medication in “teaspoons.” However, information associated with the medication in question includes that this medication should be taken in “milliliters.” Thus, the quality alert message 450 includes a possible warning or alert message to this effect, and suggests that pharmacy or other personnel check the directions and the calculation for the correct number of milligrams per dose. Quality alert message window 450 can also include an initials field 452 for entering the initials of the personnel into the field (shown as “AAA” in FIG. 4) for overriding the alert if the information is correct according to the personnel reviewing the information in the data review interface screen 440. An override button 454 is provided to complete the override after the initials of the personnel have been entered. In one embodiment, the override button 454 can only be pressed after initials have been entered in the initials field 452. In another embodiment, the initials must match the user that is logged into the user session through which the data review interface screen 440 is being viewed, before the override button 454 can be pressed.

A “Create DRE” entry button 456 is provided within the quality alert message window 450 for indicating that a data review error has occurred and should be corrected. The Create DRE entry button 456 will be enabled at all times. If the pharmacy user selects the “Create DRE” button 456, the quality alert message window 450 will closed, and a “Product” push button (not shown) on the data review interface screen 440 will be unclicked and its color will be changed from green to the default color (gray). The prescription is put into a queue for correction or rejection once the “Create DRE” button 456 is clicked. The pharmacy personnel can reject the prescription after selecting “Create DRE” button 456 on the quality alert message window 450. If the prescription is rejected, the quality alert message window 450 will not pop up again when the “Accept” button 458 on data review window is clicked. The pharmacy personnel can also correct the prescription after selecting “Create DRE” button 456 on the quality alert message window 450. In one embodiment, a keyword search or comparison will be performed after the personnel selects the “Accept” button 458. The quality alert window 450 functionality, as described, can be utilized with various different users and the respective interface screens for such users. In one embodiment, the quality alert message window 450 will be displayed off-center allowing the directions entry field 446 within the data review interface screen 440 to be visible.

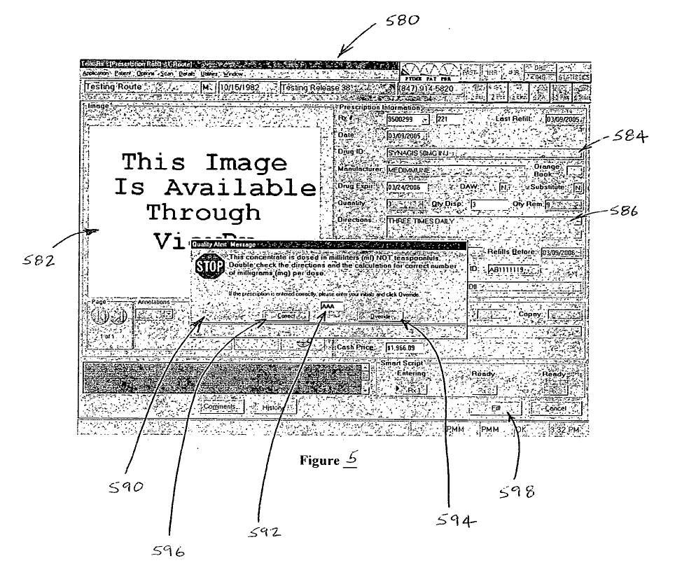

Referring to FIG. 5, a further embodiment of a prescription entry interface screen 580 is shown. This interface screen 580 can be used to enter prescriptions into the system 100. In particular, this interface screen 580 is used to enter a prescription while using an image capture of the actual written prescription, which would be shown in the prescription image area 582 (a prescription is not actually shown in image area within FIG. 5). The prescription entry interface screen 580 also allows for entry of the patient name and other information similar to the prescription entry interface screen 102 of FIG. 3. Also similar to the prescription entry interface screen 102 of FIG. 3, after the pharmacy personnel enters the identification of the medication in medication field 584, and when the directions are entered into the directions field 586, the system will determine if the directions data is consistent with the drug name entered into the drug or medication identification field 584, as described above.

The data review interface screen 600 and other windows and aspects shown in FIG. 6 include the same functionality of the data review interface screen 440 and other windows and aspects of FIG. 4. However, the data review interface screen 600 does not include an image of the actual written prescription.

A quality alert message 590 is also shown in FIG. 5. In particular, when the comparison reveals an inconsistency between the entered medication data and the entered directions data, the pharmacy entry and fill computer 200, 300, 400 and/or 500 will transmit a message to a display of a communication device, such as the input device 230, 330, 430, 550, and/or 570 for viewing by pharmacy personnel. The message will indicate there may be a possible error with the directions being entered for the prescription in question. In the quality alert message 590 of FIG. 5, the system has detected that the directions field 586 and/or other field includes an indication that the previously entered prescription may include an indication to take the medication in “teaspoons.” However, information associated with the medication in question includes that this medication should be taken in “milliliters.” Thus, the quality alert message 590 includes a possible warning or alert message to this effect, and suggests that pharmacy or other personnel check the directions and the calculation for the correct number of milligrams per dose. Quality alert message window 590 can also include an initials field 592 for entering the initials of the personnel into the field (shown as “AAA” in FIG. 5) for overriding the alert if the information is correct according to the personnel entering the information into the prescription entry interface screen 580. An override button 594 is provided to complete the override after the initials of the personnel have been entered. In one embodiment, the override button 594 can only be pressed after initials have been entered in the initials field 592. In another embodiment, the initials must match the user that is logged into the user session through which the prescription entry interface screen 580 is being viewed, before the override button 594 can be pressed. A “correct” button 596 is provided to allow the pharmacy personnel to go back and change the contents of the directions entry field 586 or other field to make corrections, such as if the personnel determines that the directions are not consistent with the medication within the prescription. The personnel can alternatively or also contact the doctor or other prescribing individual to verify that such corrections are appropriate or warranted.

The prescription entry interface screen 700 and other windows and aspects shown in FIG. 7 include the same functionality of the prescription entry interface screen 580 and other windows and aspects of FIG. 5. However, the prescription entry interface screen 700 does not include an image of the actual written prescription.

The checks and comparisons of the prescription directions information entered into the direction field 128, 446, 586 or other field are checked and/or compared to keywords entered through a “quality alert” or directions keyword entry interface screen 900 shown in FIG. 9. The pharmacy or other personnel can review, enter or modify medication information within the medication portion of the prescription, patient, and/or medication database 210, 310, 410, 510 through a drug information interface screen 800. A quality alert button 810 is provided at the bottom of the drug information interface screen 800 for the pharmacy or other personnel to access and use the directions keyword entry interface screen 900 shown in FIG. 9. Keywords can be entered into a keyword entry field 910 through the input devices 230, 330, 430, 550, 570, for use in performing the checks or comparisons to the prescription directions information. In one embodiment, only supervisory or corporate personnel can enter and maintain the keywords and the warning messages for a specific drug. In such an embodiment, only supervisory or corporate personnel will be given access to the “quality alert” or directions keyword entry interface screen 900.

The quality alert interface screen 900 also includes a “present” radio button 912 and an “absent” radio button 914, to indicate whether the keywords need to be present or absent in order for a quality alert message window such as the quality alert message windows 450, 590 shown in FIGS. 4 and 5, to be launched. If the indicator is set at “present,” at least one of the key words must be present in the directions, otherwise the quality alert message window 450, 590 will be displayed. If the indicator is set at “absent,” all the key words must be absent from directions field, otherwise the quality alert message window 450, 590 will be displayed. In one such embodiment, both “present” and “absent” cannot be used. In other embodiments, the combinations of both absent and present keywords can be utilized to launch a quality alert message window. The characters that can be entered in the keyword entry field 910 and used within the determination or comparison can include letters, numbers, other characters and combinations thereof In another embodiment, multiple quality alerts using different keywords for each (and different messages therefore) can be entered and utilized for the same medication.

The quality alert interface screen 900 also includes an “SE” or prescription entry radio button 920, a “DR” or data review radio button 922, and a “SE/DR” or both prescription entry and data review radio button 924, for allowing the personnel to select at which respective interface screens they should be checking for (comparison of) the occurrence of keywords, as can be understood with reference to the above description. The quality alert interface screen 900 also includes a quality alert message entry field 930 for entering the warning or alert message that will be launched if the logic determines that the launch should occur. An “OK” button 940 is also provided for indicating the user or personnel has completed entering the present quality alert information into the quality alert entry interface screen 900. In one embodiment, if the quality alert entry interface screen 900 is saved without any keywords being entered into the keywords entry field 910, a null value will be saved in the keyword portion of the prescription, patient, and/or medication database 210, 310, 410, 510 for this field, indicating that no quality alert searching should be done for this drug. In such case, the error message does not necessarily need to be deleted to disable the quality alert checking or searching, although it should be deleted if it is anticipated that it will never be used again. In another embodiment, if keywords are entered, then all other fields must be entered.

As mentioned, keywords can be single words or multiple words between commas. In this embodiment, keywords cannot contain commas. However, in other embodiments, keywords may include commas, if the separator is another character. Whatever is entered into the keyword entry field 930 will be saved as a string. The pharmacy management software 220, 320, 420, 520 of system 100 will split apart the keywords, stripping any leading or trailing spaces and perform each comparison using each keyword to perform the requested logic to determine if a quality alert message should be launched. In one embodiment, the entered keywords can be in multiple languages and comparisons can be performed in multiple languages, such as English and Spanish, at one time.

Quality alert messages can be displayed at the data review interface screen for the first fill and first refill for specific medications or drugs. Quality alert messages can also be displayed at the prescription entry interface screen for the first fill for specific medications or drugs. As mentioned, in one embodiment, if the pharmacy personnel overrides the quality alert message by clicking the “Override” button on the quality alert message window, the quality alert message window will be closed and the focus will go to the next field after Directions field in the prescription entry interface window. If the pharmacy personnel decides to modify the directions by entering their initials and clicking the “Correct” button on the quality alert message window, the quality alert message window will be closed and the focus will go back to directions entry field. Once the pharmacy personnel has clicked either “Correct” or “Override” buttons in the quality alert message window, the quality alert message will not pop up again in the prescription entry interface screen when the pharmacy personnel tabs off directions entry field, if there is no change made to the directions or the changes don't break the keyword search rule (which will cause another quality alert message window to appear).

In one embodiment, initials entered in at the pop-up quality alert message window in the data review interface screen will not be saved in the database, but the system 100 can be set up to do so. However, the data reviewer's ID can be saved as a part of log-in and can used for quality control purposes.

The following chart provides information of one data implementation of the present invention:

| | | Not | |
|---|---|---|---|
| Column | Data Type | NULL? | Description |
| Quality | 250 Characters | NULL | the quality alert message |
| Alert | | | that will pop up if a keyword |
| Message | | | rule is broken. |
| Keyword(s) | 65 Characters | NULL | string of comma-separated |
| | | | keywords. |
| Comparison | 1 Character | NULL | the rule that will be |
| Rule | | | applied to the keywords. |
| | | | Values: |
| | | | ‘P’ - At least 1 |
| | | | of the keywords must be |
| | | | Present, or the error is |
| | | | triggered. |
| | | | ‘A’ - All of the |
| | | | keywords must be Absent, or |
| | | | the error is triggered. |
| Interface | 1 Character | NULL | the screen(s) where the |
| Screen To | | | keywords rule will be |
| Implement | | | tested. |
| | | | Values: |
| | | | ‘S’ - Prescription Entry |
| | | | ‘D’ - Data Review |
| | | | ‘B’ - Both |

The present invention is also directed to a system and method of preventing internal pharmacy errors for a specialty prescription. Some medications or drugs, such as Accutane, Clozaril, Tikosyn, Lotronex, and others have dispensing restrictions. Thus, the present invention is also directed to providing pharmacy personnel quick access to dispensing and/or filling information to properly meet FDA approved dispensing restrictions for specialty drugs, such as these specialty drugs. As a precaution, the system and method can be set up to block the filling/dispensing of a prescription that violates these restrictions. Thus, the system and method can add or modify dispensing restrictions for the select drug, add or remove the number of drugs associated with dispensing restrictions.

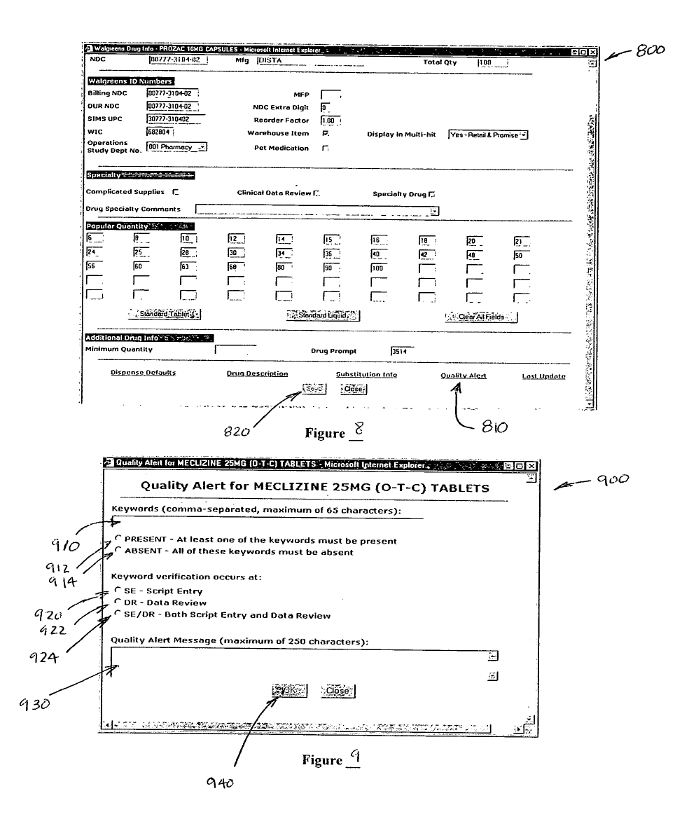

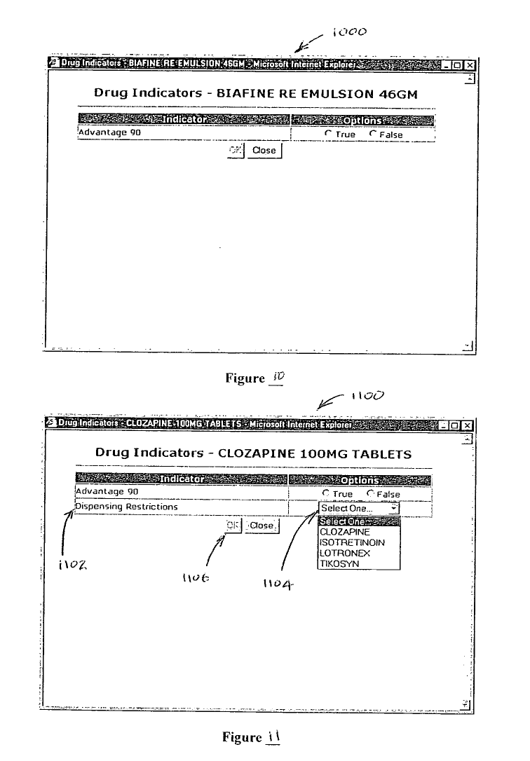

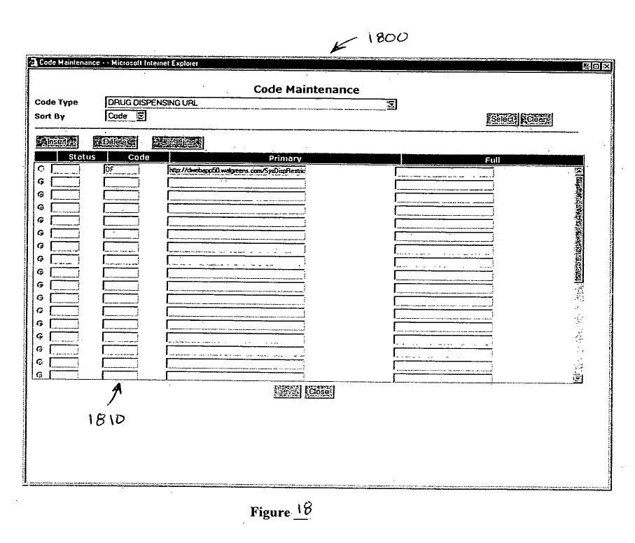

Referring to FIGS. 10 and 11, a drug indicators interface screens 1000, 1100 are shown. These interface screens 1000, 1100 are used by supervisory and/or corporate personnel to configure medications or drugs within the system 100, and the prescription, patient, and/or medication database(s) 210, 310, 410, 510 therein. In the drug indicators interface screen 1000 of FIG. 10, no dispensing restrictions are provided as the drug shown in FIG. 10, “Biafine Re Emulsion 46 GM,” is not a drug for which dispensing restrictions have set up to be required or selectable. However, in the drug indicators interface screen 1100 of FIG. 11, dispensing restrictions are provided for selection for the drug shown in FIG. 11, as “Clozapine 100 MG Tablets” is a drug for which dispensing restrictions are selectable. The drug indicators interface screens 1000, 1100 will either include a dispensing restriction, or not include dispensing restrictions set up, based upon inputs in a code maintenance interface screen 1800, as will be described in greater detail below with reference to FIG. 18. Thus, in the drug indicators interface screen 1100 of FIG. 11, a value for dispensing restrictions 1102 must be selected for the medication identified in that interface screen 1100 through a dispensing restrictions value selection field 1104. In one embodiment, values for the dispensing restrictions can include “CLOZAPINE”, “ISOTRETINOIN”, “LOTRONEX”, “TIKOSYN”, “ACCUTANE” (not shown), and “METHOTREXINE” (not shown) and blank, indicated by the wording “Select One . . . ” in FIG. 11. A blank value indicates that no dispensing restrictions are associated with the drug. The dispensing restrictions indicator value, if set, will be saved for the drug after both the “OK” button 1106 on the drug indicators interface screen 1100, and the “Save” button 820 on an add drug interface screen (not shown) or drug info interface screen 800 shown in FIG. 8, has been pressed. In one embodiment, after a value has been specified for the dispensing restrictions indicator 1102, the value can no longer be changed, except through removal of the drug indicator from the code maintenance interface screen 1800, and adding it back thereto. An appropriate set of dispensing restriction tasks is entered and stored in the prescription, patient, and/or medication database(s) 210, 310, 410, 510 for each dispensing restriction value selectable from the dispensing restrictions value selection field 1104, as will be described below and shown in the related Figures.

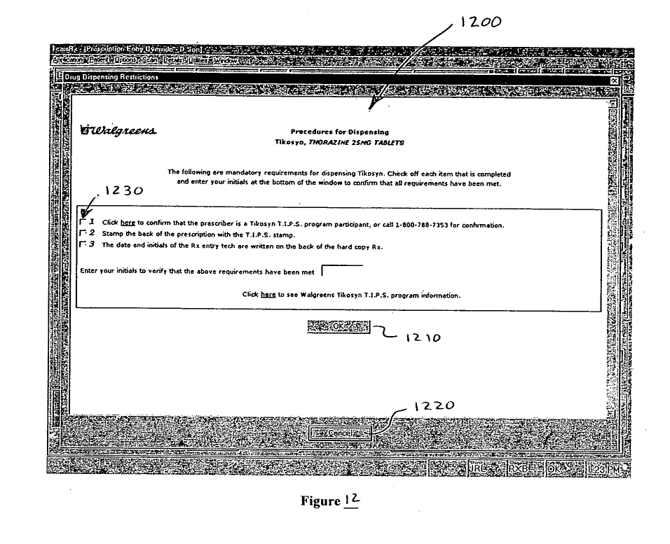

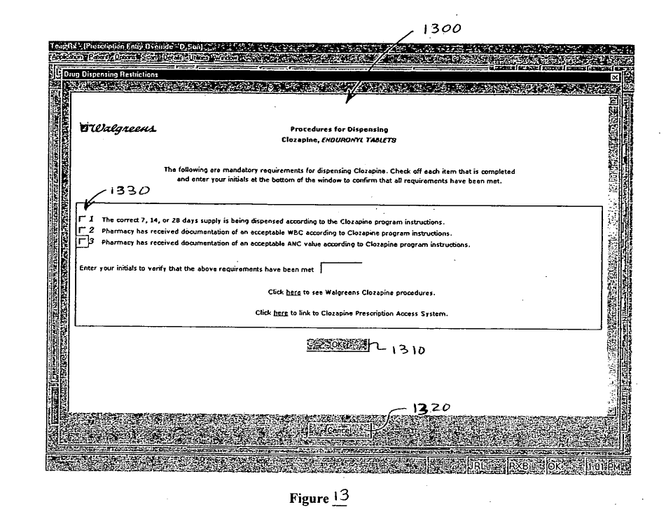

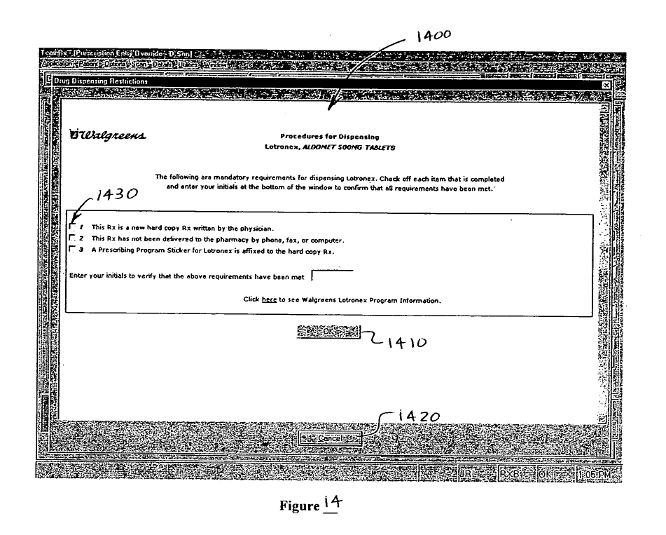

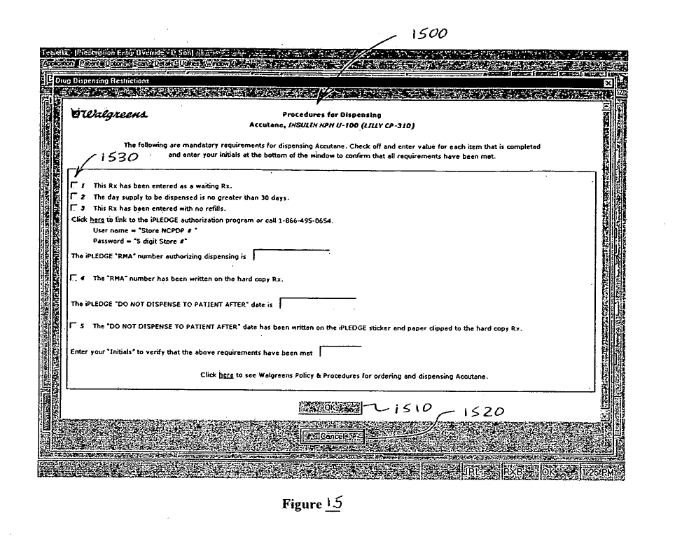

Referring to FIGS. 12 through 17, in one embodiment, when a medication is being filled and dispensed, validation and launching of a dispensing restrictions task window 1200, 1300, 1400, 1500, 1600, 1700 will occur after all other fields are validated within the prescription entry interface screen 102, 580, 700. For example, if a required field is blank within a prescription entry interface screen 102, 580, 700, once a “Fill” button 598 (FIG. 5) is clicked, the personnel will be alerted that additional information is still required, and the personnel will have to press the “Fill” button 598 again before drug can be validated. Once the “Fill” button 598, shown in FIG. 5, is clicked, if an entered/modified prescription is for medication or drug which has been set up for dispensing restrictions, then a dispensing restrictions task window 1200, 1300, 1400, 1500, 1600, 1700 will pop up. Dispensing restriction tasks are set out within each dispensing restrictions task window 1200, 1300, 1400, 1500, and 1600, required to be performed or followed before filling can continue. Each specific “specialty” drug for which dispensing restrictions are required, will have its own specific dispensing restriction task(s). FIG. 12 shows dispensing restriction tasks for Tikosyn. FIG. 13 shows dispensing restriction tasks for Clozapine. FIG. 14 shows dispensing restriction tasks for Lotronex. FIG. 15 shows dispensing restriction tasks for Accutane.

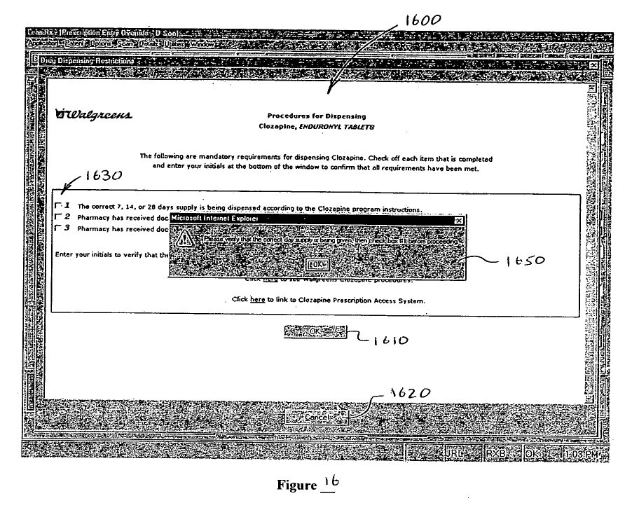

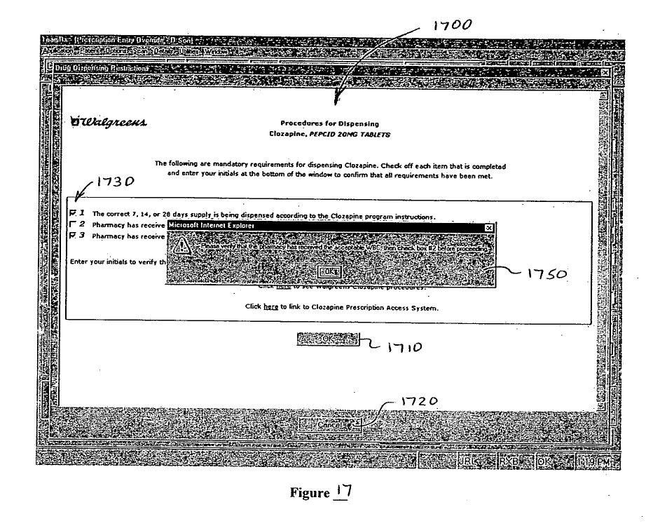

Each dispensing restrictions task window 1200, 1300, 1400, 1500, 1600, 1700 contains an “OK” button 1210, 1310, 1410, 1510, 1610, 1710. Once the “OK” button is clicked, a validation process will take place, checking that all fields on the form have been filled in. If validation passes, the dispensing restrictions task window 1200, 1300, 1400, 1500, 1600, 1700 will be closed, and the fill process will continue. If validation fails, dispensing restrictions task window 1200, 1300, 1400, 1500, 1600, 1700 will stay open and an error alert message 1650, 1750 will pop up warning to the personnel to re-enter correct information, as shown in FIGS. 16 and 17. Each of the dispensing restrictions task windows 1200, 1300, 1400, 1500, 1600, 1700 also has a “Cancel” button 1220, 1320, 1420, 1520, 1620, 1720. In one embodiment, if the Cancel” button 1220, 1320, 1420, 1520, 1620, 1720 is clicked, the dispensing restrictions task windows 1200, 1300, 1400, 1500, 1600, 1700 will be closed, and the fill process will be halted. The prescription entry interface screen will then be reset for a new prescription, and to continue filling for the drug in question, the whole process will have to be started from the beginning.

As mentioned, in each of the dispensing restrictions task windows 1200, 1300, 1400, 1500, 1600, 1700, one or more tasks are required to be performed before the fill process can continue. To verify that each task or compliance verification data has been performed, a check-off box 1230, 1330, 1430, 1530, 1630, 1730 can be provided in the display for each task, requiring the pharmacy personnel check off that the pharmacy personnel has complied with the specialty prescription dispensing task. In another embodiment, other interfacing mechanisms for receiving verification data, other than using check-off boxes, can be utilized.

In the process of utilizing the method and system of one embodiment of the present invention, the prescription data received through the prescription entry interface screen 102 shown in FIG. 3, including the identification of the prescribed medication, entered in medication entry field 124, is transmitted to the pharmacy computer memory 206, 306, 406, 506 associated with the pharmacy prescription entry and fill computer 200, 300, 400, 500. The pharmacy entry and fill computer 200, 300, 400, 500 compares the medication data for the prescription to specialty prescription data, stored in a specialty prescription database 210, 310, 410, 510 associated with the pharmacy entry and fill computer 200, 300, 400, 500 and the pharmacy computer memory 206, 306, 406, 506. Specialty prescription dispensing task information, for example shown in FIGS. 12-17, is transmitted to a display of a communication device 230, 330, 430, 550, 570 for viewing by pharmacy personnel, and for preventing the pharmacy personnel from dispensing the prescription without performing the specialty prescription dispensing task, in response to the comparison.

Dispensing restrictions task window 1200, 1300, 1400, 1500, 1600, 1700 will be launched as well if the medication or drug is changed to one of the defined “specialty” drugs for which dispensing restrictions have been defined, as described above. Upon changing of a drug, functions such as update, copy/create, transfer, hold/save prescription can be used, which will check for such specialty drug identification, and cause the launch to occur for such specialty drugs. In one embodiment, the present invention can be implemented through the prescription entry interface screens discussed above, for new prescriptions entry, and within update prescription interface screens, partial fill interface screens and other screens (not shown).

Referring to FIG. 18, a code maintenance interface screen 1800 is shown for identifying when certain interface screens should be launched. In one embodiment, a specialty code can be set up and entered in a code entry field 1810 to launch screens associated with entering the dispensing restriction values through the dispensing restriction values entry field 1104, such as drug indications interface screen 11 shown in FIG. 11. Other mechanisms and/or interface screens can be used to set up and maintain when dispensing restrictions task windows 1200, 1300, 1400, 1500, 1600, 1700 should be launched for certain specialty drugs.

The above systems and methods can be integrated with quality control management and improvement systems and methods, such as the system and method disclosed in U.S. patent application Ser. No. 11/264,363, filed Nov. 1, 2005, entitled Integrated Pharmacy Error Tracking and Reporting System and Method, the contents of which are hereby incorporated by reference herein.

Any process descriptions or blocks in the figures may be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It will be understood that the invention may be embodied in other specific forms without departing from the spirit or central characteristics thereof. The present embodiments, therefore, are to be considered in all respects illustrative and not restrictive, and the invention is not to be limited to the details given herein.

What is claimed is:

1. A method of preventing pharmacy errors for a prescription, comprising the steps of:
receiving prescription data comprising medication data and direction data for the delivery of medication identified within the medication data for the prescription;
transmitting the prescription data to a pharmacy computer memory associated with a pharmacy prescription entry and fill computer;
comparing, at the pharmacy entry and fill computer, the direction data for the prescription to error prevention keyword data for the medication data, stored in an error prevention keyword database associated with the pharmacy entry and fill computer and the pharmacy computer memory; and,
transmitting a possible directions error message to a display of a communication device for viewing by pharmacy personnel in response to the comparing step.

2. The method of claim 1 wherein the prescription data further comprises patient data and prescriber data.

3. The method of claim 1 wherein the step of comparing only occurs when the medication data comprises a predetermined medication.

4. The method of claim 1 wherein the error prevention keyword data comprises an error prevention keyword, and wherein if the direction data does not comprise the error prevention keyword, then the possible directions error message will be transmitted to the display of the communication device.

5. The method of claim 1 wherein the error prevention keyword data comprises an error prevention keyword, and wherein if the direction data comprises the error prevention keyword, then the possible directions error message will be transmitted to the display of the communication device.

6. The method of claim 1 wherein the error prevention keyword data comprises a plurality of error prevention keywords, and wherein if the direction data does not comprise all of the plurality of error prevention keywords, then the possible directions error message will be transmitted to the display of the communication device.

7. The method of claim 1 wherein the error prevention keyword data comprises a plurality of error prevention keywords, and wherein if the direction data comprises all of the plurality of error prevention keywords, then the possible directions error message will be transmitted to the display of the communication device.

8. The method of claim 1 wherein the error prevention keyword data comprises a plurality of error prevention keywords, and wherein if the direction data does not comprise at least one of the plurality of error prevention keywords, then the possible directions error message will be transmitted to the display of the communication device.

9. The method of claim 1 wherein the error prevention keyword data comprises a plurality of error prevention keywords, and wherein if the direction data comprises at least one of the plurality of error prevention keywords, then the possible directions error message will be transmitted to the display of the communication device.

10. The method of claim 1 wherein the step of transmitting further comprises transmitting the possible directions error message to a display of a communication device while the display is displaying one of a prescription entry interface screen or a prescription data review interface screen.

11. The method of claim 1 further comprising the steps of:
receiving the error prevention keyword data for a particular medication;
transmitting the error prevention keyword data for the particular medication; and,
storing error prevention keyword data in the error prevention keyword database associated with the pharmacy entry and fill computer.

12. A system for preventing pharmacy errors for a prescription, comprising:
an input device for receiving prescription data comprising medication data and direction data for the delivery of medication identified within the medication data for the prescription;
a pharmacy computer memory in communication with the input device for receiving the prescription data from the input device;
a pharmacy prescription entry and fill computer in communication with the pharmacy computer memory, configured to compare the direction data for the prescription to error prevention keyword data for the medication data,
an error prevention keyword database in communication with the pharmacy entry and fill computer and the pharmacy computer memory, wherein the error prevention keyword database is configured to store the error prevention keyword data; and,
a communication device having a display configured to receive and display a possible directions error message for viewing by pharmacy personnel in response to the pharmacy prescription entry and fill computer comparing the direction data to the error prevention keyword data.

13. The system of claim 12 wherein the error prevention keyword database is configured to receive and store error prevention keyword data for each of a plurality of particular medications.

14. A method of preventing pharmacy errors for a specialty prescription, comprising the steps of:
receiving prescription data comprising medication data for a prescription;
transmitting the prescription data to a pharmacy computer memory associated with a pharmacy prescription entry and fill computer;
comparing, at the pharmacy entry and fill computer, the medication data for the prescription to specialty prescription data, stored in a specialty prescription database associated with the pharmacy entry and fill computer and the pharmacy computer memory; and,
transmitting first specialty prescription dispensing task information to a display of a communication device for viewing by pharmacy personnel, and for preventing the pharmacy personnel from dispensing the prescription without performing the first specialty prescription dispensing task, in response to the comparing step.

15. The method of claim 14 wherein the step of transmitting the first specialty prescription dispensing task information comprises transmitting first compliance verification data for viewing by the pharmacy personnel, requiring the pharmacy personnel to verify that the pharmacy personnel has complied with the first specialty prescription dispensing task, wherein the pharmacy personnel cannot complete filling the prescription until the first specialty prescription dispensing task has been verified.

16. The method of claim 15 wherein the first compliance verification data comprises data for causing a check-off box to displayed on the display of the communication device, requiring the pharmacy personnel to check off that the pharmacy personnel has complied with the first specialty prescription dispensing task.

17. The method of claim 14 wherein the first specialty prescription dispensing task information is transmitted to the display of the communication device only if the medication data comprises a medication selected from the group consisting of clozapine, isotretinoin, Lotronex, Tikosyn, Accutane, and methotrexine.

18. The method of claim 14 further comprising the steps of:
receiving first specialty prescription dispensing task information for a particular specialty medication;
transmitting the first specialty prescription dispensing task information for the particular specialty medication; and,
storing the first specialty prescription dispensing task information in the specialty prescription database associated with the pharmacy entry and fill computer.
